(19) United States
(12) Patent Application Publication
(10) Pub. No.: US 2010/0287938 A1
(43) Pub. Date: Nov. 18, 2010

(54) CROSS FLOW VANE

(75) Inventors: Ramanand Singh, Bangalore Karnataka (IN); Mahesh Bathina, Bangalore Karnataka (IN)

Correspondence Address: SUTHERLAND ASBILL & BRENNAN LLP, 999 PEACHTREE STREET, N.E., ATLANTA, GA, 30309, US

(73) Assignee: General Electric Company, Schnectady, NY (US)

(21) Appl. No.: 12/465,692

(22) Filed: May 14, 2009

(51) Int. Cl. F02C 7/22

(52) U.S. Cl. 60/740

(57) ABSTRACT

The present application provides a cross flow vane for a turbine. The cross flow vane may include a number of jets positioned therein and a divider positioned within one or more of the jets so as to form a number of fuel slots therein.

### TECHNICAL FIELD

The present application relates generally to gas turbine engines and more particularly relates to a cross flow swozzle vane that reduces flame holding and pressure drop.

### BACKGROUND OF THE INVENTION

A jet in cross flow occurs when a flow of a fluid exits an orifice to interact with an intersecting flow of a fluid that is flowing across the orifice. Jets in cross flow are central to a variety of applications such as gas turbine combustors, fuel injectors, and pollution controls in smoke stacks. A jet in cross flow typically creates a zone of recirculation downstream from where the cross flow is introduced. The recirculation zone typically has a reduced flow velocity that may cause a variety of detrimental effects depending upon the configuration of the flow.

More specifically, the recirculation zone behind a jet in cross flow of a turbine swozzle vane may hold the air fuel mixture. Due to the high temperatures in the combustor, flames may flash back and try to hold in the low velocity region. Further, a local spark may ignite the air fuel mixture trapped in the recirculation zone. The recirculation zone thus aids in holding the flame. The problem may be more prominent in cases of fuels with high BTU such as hydrogen (H₂) due to higher flame speed. Likewise for low BTU fuels such as BFG (Blast Furnace Gas), the recirculation zone may form due to the high volumetric flow rate.

There is thus a desire for improved swozzle vane jets particularly in a jet in cross flow design. The improved design should reduce flame holding and the pressure drop therethrough so as to improve overall system performance and efficiency.

### SUMMARY OF THE INVENTION

The present application thus provides a cross flow vane for a turbine. The cross flow vane may include a number of jets positioned therein and a divider positioned within one or more of the jets so as to form a number of fuel slots therein.

The present application further provides a cross flow system for a gas turbine. The cross flow system may include a vane, a first flow flowing over the vane, a jet positioned on the vane, a second flow exiting the jet and intersecting the first flow, a divider positioned within the jet so as to divide the second flow, and a fuel curtain slot positioned about the jet to guide the first flow.

The present application further provides a cross flow swozzle vane for a gas turbine. The cross flow swozzle vane may include a number of jets positioned therein, a divider positioned within one or more of the jets so as to form a number of fuel slots therein, and a fuel curtain slot positioned about one or more of the jets.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine.

FIG. 2 is a perspective view of a combustor swozzle.

FIG. 3 is a perspective view of a portion of a swozzle vane as is described herein.

FIG. 4 is a plan view of an alternative embodiment of a swozzle vane jet as is described herein.

FIG. 5 is a plan view of an alternative embodiment of a swozzle vane jet as is described herein.

FIG. 6 is a plan view of an alternative embodiment of a swozzle vane jet as is described herein.

### DETAILED DESCRIPTION

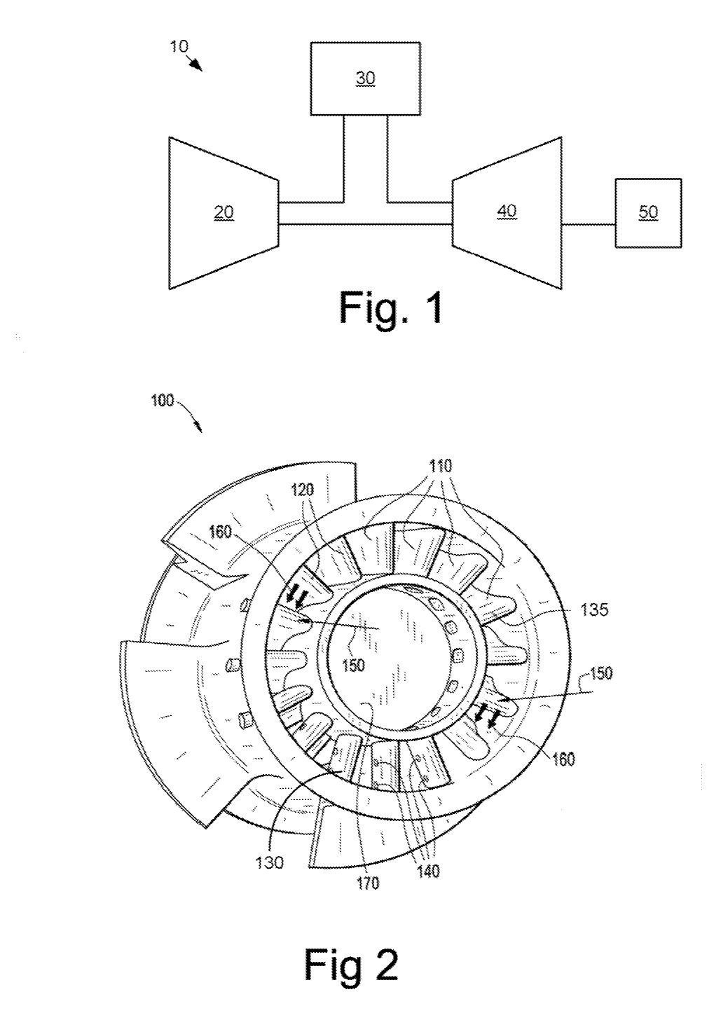

Referring now to the drawings, in which like numbers refer to like elements throughout the several views, FIG. 1 shows a schematic view of a gas turbine engine 10. As is known, the gas turbine engine 10 may include a compressor 20 to compress an incoming flow of air. The compressor 20 delivers the compressed flow of air to a combustor 30. The combustor 30 mixes the compressed flow of air with a compressed flow of fuel and ignites the mixture. (Although only a single combustor 30 is shown, the gas turbine engine 10 may include any number of combustors 30.) The hot combustion gases are in turn delivered to a turbine 40. The hot combustion gases drive the turbine 40 so as to produce mechanical work. The mechanical work produced in the turbine 40 drives the compressor 20 and an external load 50 such as an electrical generator and the like. The gas turbine engine 10 may use natural gas, various types of syngas, and other types of fuels. The gas turbine engine 10 may have other configurations and may use other types of components. Multiple gas turbine engines 10, other types of turbines, and other types of power generation equipment may be used herein together.

FIG. 2 shows a known combustor swozzle 100 that may be used with the combustor 30 described above or otherwise. The combustor swozzle 100 includes a number of swozzle vanes 110. Each of the swozzle vanes 110 has a leading edge 120, a first surface 130, and a second surface 135. The first surface 130 may have at least one cross flow jet 140 positioned therein. Similarly, the second surface 135 may have at least one cross flow jet 140 positioned therein. During the combustion process, a first flow 150 of compressed air approaches the leading edge 120 of the swozzle vane 110 and flows across the surfaces 130, 135. A second flow 160 of combustor fuel is provided by a fuel chamber 170 and is expelled from the cross flow jet 140 at an intersecting angle to the first flow 150. The swozzle vanes 110 may or may not be curved in profile up to about ninety degrees (90°) downstream from the cross flow jet 140 so as to mix and swirl the combination of the two flows 150, 160.

The second flow 160 may be a jet of combustible fuel such as gasoline, natural gas, propane, diesel, kerosene, E85 (85% ethanol and 15% gasoline), bio-diesel, biogas, or any other fuel used for combustion. The second flow 160 also may be any other flow of a gaseous or liquid substance or combination thereof. As described above, the first flow may be a compressed airflow or any other type of flow. Although the cross flow jets 140 are shown to be generally circular, the jets 140 may be ovular, polygonal, curved, or any other shape or combination thereof.

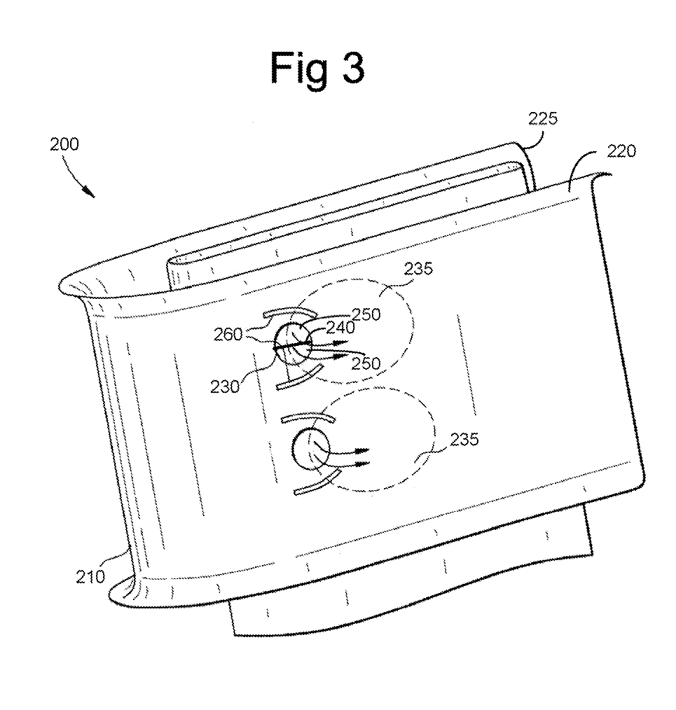

FIG. 3 shows a swozzle vane 200 as is described herein. Similar to that described above, the swozzle vane 200 includes a leading edge 210, a first surface 220, and a second surface 225. The swozzle vane 200 also includes a number of cross flow jets 230. A recirculation zone 235 may form behind the cross flow jet 230. The recirculation zone 235 may vary in size, shape, and intensity.

In this example, at least one of the cross flow jets 230 may include a divider 240 positioned therein. The divider 240 bisects the cross flow jet 230 and forms two fuel slots 250 therein. The divider 240 and the fuel slots 250 may take any desired size or shape. One or more of the cross flow jets 230 also may have one or more fuel curtain slots 260 positioned thereabout. Although the fuel curtain slot 260 is shown as somewhat curved and angled, any size, shape, or orientation may be used herein. The fuel curtain slots 260 may be similar to those shown in commonly-owned U.S. patent Ser. No. 12/262,358 and similar structures.

The use of the fuel curtain slots 260 about the cross flow jets 230 may act as a flow curtain to minimize the recirculation zone 235 behind the jet 230 by redirecting part of the air stream into the wake region. This redirection helps in mitigating flame holding in such jet in cross flow situations. The fuel slots 250 may be sized with enough of a gap therebetween caused by the divider 240 so as to allow air to pass through and wash away the wake that has formed behind the jets 230. The bifurcation of the jet 230 by the divider 240 thus may help in further reducing the recirculation zone 235 behind the jet 230 while at the same time enhancing the fuel air mixing and providing a lower pressure drop.

The cross flow jets 230 thus provide better fuel air mixing so as to provide a low risk of flame holding and, hence, greater fuel flexibility. The pressure drop thereacross likewise may be reduced by providing a larger area for the flow of fuel. Further, a lower pressure drop thus may permit a smaller fuel compressor. The cross flow jet 230 has no hard blockage for the flows so as to provide improved structural integrity. The jets 230 also may be easy to manufacture and can be retrofitted in existing frames.

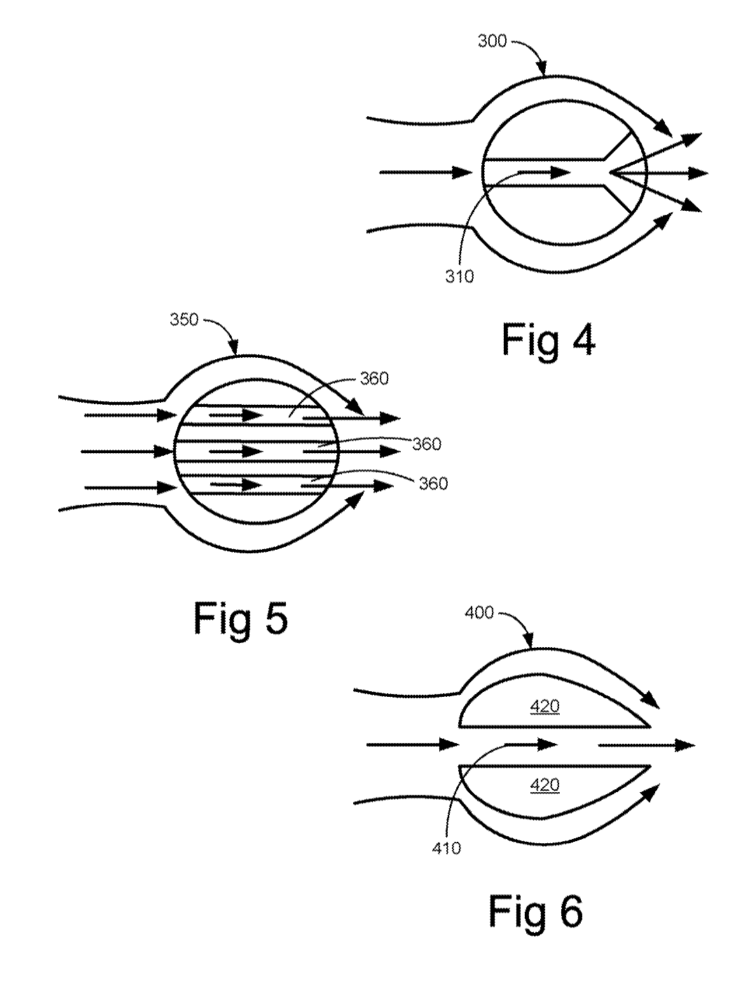

FIG. 4 shows a further embodiment of a cross flow jet 300. In this example, the jet 300 includes a divider 310 that expands in width in the downstream direction. The divider 310 thus increases the size of the central air stream so as to reduce the wake behind the jet 300. The divider 310 may have any desired size, shape, or configuration.

FIG. 5 shows a further embodiment of a cross flow jet 350. In this example, the cross flow jet 350 includes a number of dividers 360. The use of a number of dividers 360 provides for multiple air passages across the jet 350. The dividers 360 may have any desired size, shape, or configuration. Any number of dividers 360 may be used.

FIG. 6 shows a further embodiment of a cross flow jet 400. In this example, the cross flow jet 400 includes a divider 410 and a number of contoured fuel slots 420. The contoured fuel slots 420 may be used with the fuel curtain slots 260 so as to direct the air flow therethrough. The divider 410 and the slots 420 may have any desired size, shape, or configuration.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A cross flow vane for a turbine, comprising:
a plurality of jets positioned therein; and
a divider positioned within one or more of the plurality of jets so as to form a plurality of fuel slots therein.

2. The cross flow vane of claim 1, wherein the vane comprises a swozzle vane.

3. The cross flow vane of claim 1, further comprising a fuel curtain slot positioned about one or more of the plurality of jets.

4. The cross flow vane of claim 3, wherein the fuel curtain slot comprises a plurality of fuel curtain slots.

5. The cross flow vane of claim 1, wherein the divider comprises a plurality of dividers.

6. The cross flow vane of claim 1, wherein the divider comprises an expanded width on a downstream side.

7. The cross flow vane of claim 1, wherein the plurality of fuel slots comprises a contoured shape.

8. A cross flow system for a gas turbine, comprising:
a vane;
a first flow flowing over the vane;
a jet positioned on the vane;
a second flow exiting the jet and intersecting the first flow;
a divider positioned within the jet so as to divide the second flow; and
a fuel curtain slot positioned about the jet to guide the first flow.

9. The cross flow system of claim 8, wherein the vane comprises a swozzle vane.

10. The cross flow system of claim 8, wherein the fuel curtain slot comprises a plurality of fuel curtain slots.

11. The cross flow system of claim 8, wherein the divider comprises a plurality of dividers.

12. The cross flow system of claim 8, wherein the divider comprises an expanded width on a downstream side.

13. The cross flow system of claim 8, wherein the jet comprises a plurality of fuel slots.

14. The cross flow system of claim 13, wherein the plurality of fuel slots comprises a contoured shape.

15. A cross flow swozzle vane for a gas turbine, comprising:
a plurality of jets positioned therein;
a divider positioned within one or more of the plurality of jets so as to form a plurality of fuel slots therein; and
a fuel curtain slot positioned about one or more of the plurality of jets.

16. The cross flow vane swozzle of claim 15, wherein the fuel curtain slot comprises a plurality of fuel curtain slots.

17. The cross flow swozzle vane of claim 15, wherein the divider comprises a plurality of dividers.
